(19) United States
(12) Patent Application Publication
(10) Pub. No.: US 2022/0368399 A1
(43) Pub. Date: Nov. 17, 2022

(54) TECHNIQUES FOR SELECTING A BEAM PAIR USING SINGLE LAYER MEASUREMENTS

(71) Applicant: QUALCOMM Incorporated, San Diego, CA (US)

(72) Inventors: Yuan GAO, San Diego, CA (US); Mihir Vijay LAGHATE, San Diego, CA (US); Lorenzo FERRARI, Oakland, CA (US); Raghu Narayan CHALLA, San Diego, CA (US); Gautham HARIHARAN, Sunnyvale, CA (US); Danlu ZHANG, Rancho Santa Fe, CA (US); Supratik BHATTACHARJEE, San Diego, CA (US)

(21) Appl. No.: 17/320,641

(22) Filed: May 14, 2021

(51) Int. Cl. H04B 7/06; H04W 24/08; H04L 5/00

(52) U.S. Cl. CPC H04B 7/0695; H04W 24/08; H04L 5/0048

(57) ABSTRACT

Various aspects of the present disclosure generally relate to wireless communication. In some aspects, a user equipment (UE) may receive, from a base station, a single layer reference signal. The UE may perform single layer measurements associated with the single layer reference signal for a plurality of UE beam pairs. The UE may determine, based at least in part on the single layer measurements for the plurality of UE beam pairs, multiple layer measurements associated with one or more UE beam pairs of the plurality of UE beam pairs. The UE may select, from the one or more UE beam pairs, a UE beam pair based at least in part on the multiple layer measurements associated with the one or more UE beam pairs. Numerous other aspects are described.

### FIELD OF THE DISCLOSURE

Aspects of the present disclosure generally relate to wireless communication and to techniques and apparatuses for selecting a beam pair using single layer measurements.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a base station via the downlink and uplink. “Downlink” (or “forward link”) refers to the communication link from the base station to the UE, and the “uplink” (or “reverse link”) refers to the communication link from the UE to the base station. As will be described in more detail herein, a base station may be referred to as a Node B, a gNB, an access point (AP), a radio head, a transmit receive point (TRP), a New Radio (NR) base station, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a UE includes receiving, from a base station, a single layer reference signal; performing single layer measurements associated with the single layer reference signal for a plurality of UE beam pairs; determining, based at least in part on the single layer measurements for the plurality of UE beam pairs, multiple layer measurements associated with one or more UE beam pairs of the plurality of UE beam pairs; and selecting, from the one or more UE beam pairs, a UE beam pair based at least in part on the multiple layer measurements associated with the one or more UE beam pairs.

In some aspects, the method includes performing, to the base station, a multiple layer transmission based at least in part on the UE beam pair.

In some aspects, the single layer measurements are rank-1 measurements and the multiple layer measurements are rank-2 measurements.

In some aspects, the single layer reference signal is a synchronization signal block (SSB).

In some aspects, the single layer measurements associated with the single layer reference signal include one or more of: single layer reference signal received power (RSRP) measurements, single layer spectral efficiency measurements, or single layer channel frequency response measurements.

In some aspects, the multiple layer measurements are spectral efficiency measurements.

In some aspects, the determination of the multiple layer measurements comprises combining the single layer measurements based at least in part on one or more of codebook information or UE mobility measurements.

In some aspects, the determination of the multiple layer measurements comprises combining the single layer measurements using a linear model.

In some aspects, the determination of the multiple layer measurements comprises combining the single layer measurements using a non-linear model, wherein the non-linear model is trained and validated using one or more datasets associated with one or more of: channel models, UE rotations, UE analog beamforming codebooks, white noise with different signal-to-interference-plus-noise ratios (SINRs), or non-white noise with different SINRs.

In some aspects, the determination of the multiple layer measurements comprises: combining the single layer measurements using a linear model to obtain first multiple layer measurements; selecting a first UE beam pair based at least in part on the first multiple layer measurements; combining the single layer measurements using a non-linear model to obtain second multiple layer measurements; selecting a second UE beam pair based at least in part on the second multiple layer measurements; and selecting one of the first UE beam pair or the second UE beam pair based at least in part on a performance of the first UE beam pair in relation to a performance of the second UE beam pair.

In some aspects, the determination of the multiple layer measurements comprises combining the single layer measurements to obtain single layer measurements associated with the one or more UE beam pairs and the multiple layer measurements associated with the one or more UE beam pairs.

In some aspects, a method of wireless communication performed by a base station includes transmitting, to a UE, a single layer reference signal; and receiving, from the UE, a multiple layer transmission based at least in part on a UE beam pair, wherein the UE beam pair is based at least in part on the single layer reference signal.

In some aspects, the single layer reference signal is an SSB.

In some aspects, the UE beam pair is based at least in part on multiple layer measurements associated with one or more UE beam pairs of a plurality of UE beam pairs, and the multiple layer measurements are based at least in part on a combination of single layer measurements associated with the single layer reference signal.

In some aspects, the single layer measurements include one or more of: single layer RSRP measurements, single layer spectral efficiency measurements, or single layer channel frequency response measurements; and the multiple layer measurements are multiple layer spectral efficiency measurements.

In some aspects, a UE for wireless communication includes a memory and one or more processors, coupled to the memory, configured to: receive, from a base station, a single layer reference signal; perform single layer measurements associated with the single layer reference signal for a plurality of UE beam pairs; determine, based at least in part on the single layer measurements for the plurality of UE beam pairs, multiple layer measurements associated with one or more UE beam pairs of the plurality of UE beam pairs; and select, from the one or more UE beam pairs, a UE beam pair based at least in part on the multiple layer measurements associated with the one or more UE beam pairs.

In some aspects, the one or more processors are further configured to perform, to the base station, a multiple layer transmission based at least in part on the UE beam pair.

In some aspects, the single layer measurements are rank-1 measurements and the multiple layer measurements are rank-2 measurements.

In some aspects, the single layer reference signal is an SSB.

In some aspects, the single layer measurements associated with the single layer reference signal include one or more of: single layer RSRP measurements, single layer spectral efficiency measurements, or single layer channel frequency response measurements.

In some aspects, the multiple layer measurements are multiple layer spectral efficiency measurements.

In some aspects, the one or more processors, to determine the multiple layer measurements, are configured to combine the single layer measurements based at least in part on one or more of codebook information or UE mobility measurements.

In some aspects, the one or more processors, to determine the multiple layer measurements, are configured to combine the single layer measurements using a linear model.

In some aspects, the one or more processors, to determine the multiple layer measurements, are configured to combine the single layer measurements using a non-linear model, wherein the non-linear model is trained and validated using one or more datasets associated with one or more of: channel models, UE rotations, UE analog beamforming codebooks, white noise with different SINRs, or non-white noise with different SINRs.

In some aspects, the one or more processors, to determine the multiple layer measurements, are configured to: combine the single layer measurements using a linear model to obtain first multiple layer measurements; select a first UE beam pair based at least in part on the first multiple layer measurements; combine the single layer measurements using a non-linear model to obtain second multiple layer measurements; select a second UE beam pair based at least in part on the second multiple layer measurements; and select one of the first UE beam pair or the second UE beam pair based at least in part on a performance of the first UE beam pair in relation to a performance of the second UE beam pair.

In some aspects, the one or more processors, to determine the multiple layer measurements, are configured to combine the single layer measurements to obtain single layer measurements associated with the one or more UE beam pairs and the multiple layer measurements associated with the one or more UE beam pairs.

In some aspects, a base station for wireless communication includes a memory and one or more processors, coupled to the memory, configured to: transmit, to a UE, a single layer reference signal; and receive, from the UE, a multiple layer transmission based at least in part on a UE beam pair, wherein the UE beam pair is based at least in part on the single layer reference signal.

In some aspects, the single layer reference signal is an SSB.

In some aspects, the UE beam pair is based at least in part on multiple layer measurements associated with one or more UE beam pairs of a plurality of UE beam pairs, and the multiple layer measurements are based at least in part on a combination of single layer measurements associated with the single layer reference signal.

In some aspects, the single layer measurements include one or more of: single layer RSRP measurements, single layer spectral efficiency measurements, or single layer channel frequency response measurements; and the multiple layer measurements are multiple layer spectral efficiency measurements.

In some aspects, a non-transitory computer-readable medium storing a set of instructions for wireless communication includes one or more instructions that, when executed by one or more processors of a UE, cause the UE to: receive, from a base station, a single layer reference signal; perform single layer measurements associated with the single layer reference signal for a plurality of UE beam pairs; determine, based at least in part on the single layer measurements for the plurality of UE beam pairs, multiple layer measurements associated with one or more UE beam pairs of the plurality of UE beam pairs; and select, from the one or more UE beam pairs, a UE beam pair based at least in part on the multiple layer measurements associated with the one or more UE beam pairs.

In some aspects, the one or more instructions further cause the UE to perform, to the base station, a multiple layer transmission based at least in part on the UE beam pair.

In some aspects, the single layer measurements are rank-1 measurements and the multiple layer measurements are rank-2 measurements.

In some aspects, the single layer reference signal is an SSB.

In some aspects, the single layer measurements associated with the single layer reference signal include one or more of: single layer RSRP measurements, single layer spectral efficiency measurements, or single layer channel frequency response measurements.

In some aspects, the multiple layer measurements are spectral efficiency measurements.

In some aspects, the one or more instructions further cause the UE to combine the single layer measurements based at least in part on one or more of codebook information or UE mobility measurements.

In some aspects, the one or more instructions further cause the UE to combine the single layer measurements using a linear model.

In some aspects, the determination of the multiple layer measurements comprises combining the single layer measurements using a non-linear model, wherein the non-linear model is trained and validated using one or more datasets associated with one or more of: channel models, UE rotations, UE analog beamforming codebooks, white noise with different SINRs, or non-white noise with different SINRs.

In some aspects, the determination of the multiple layer measurements comprises: combining the single layer measurements using a linear model to obtain first multiple layer measurements; selecting a first UE beam pair based at least in part on the first multiple layer measurements; combining the single layer measurements using a non-linear model to obtain second multiple layer measurements; selecting a second UE beam pair based at least in part on the second multiple layer measurements; and selecting one of the first UE beam pair or the second UE beam pair based at least in part on a performance of the first UE beam pair in relation to a performance of the second UE beam pair.

In some aspects, the one or more instructions further cause the UE to combine the single layer measurements to obtain single layer measurements associated with the one or more UE beam pairs and the multiple layer measurements associated with the one or more UE beam pairs.

In some aspects, a non-transitory computer-readable medium storing a set of instructions for wireless communication includes one or more instructions that, when executed by one or more processors of a base station, cause the base station to: transmit, to a UE, a single layer reference signal; and receive, from the UE, a multiple layer transmission based at least in part on a UE beam pair, wherein the UE beam pair is based at least in part on the single layer reference signal.

In some aspects, the single layer reference signal is an SSB.

In some aspects, the UE beam pair is based at least in part on multiple layer measurements associated with one or more UE beam pairs of a plurality of UE beam pairs, and the multiple layer measurements are based at least in part on a combination of single layer measurements associated with the single layer reference signal.

In some aspects, the single layer measurements include one or more of: single layer RSRP measurements, single layer spectral efficiency measurements, or single layer channel frequency response measurements; and the multiple layer measurements are multiple layer spectral efficiency measurements.

In some aspects, an apparatus for wireless communication includes means for receiving, from a base station, a single layer reference signal; means for performing single layer measurements associated with the single layer reference signal for a plurality of apparatus beam pairs; means for determining, based at least in part on the single layer measurements for the plurality of apparatus beam pairs, multiple layer measurements associated with one or more apparatus beam pairs of the plurality of apparatus beam pairs; and means for selecting, from the one or more apparatus beam pairs, a apparatus beam pair based at least in part on the multiple layer measurements associated with the one or more apparatus beam pairs.

In some aspects, the apparatus includes means for performing, to the base station, a multiple layer transmission based at least in part on the apparatus beam pair.

In some aspects, the single layer measurements are rank-1 measurements and the multiple layer measurements are rank-2 measurements.

In some aspects, the single layer reference signal is an SSB.

In some aspects, the single layer measurements associated with the single layer reference signal include one or more of: single layer RSRP measurements, single layer spectral efficiency measurements, or single layer channel frequency response measurements.

In some aspects, the multiple layer measurements are spectral efficiency measurements.

In some aspects, the means for determining the multiple layer measurements comprises combining the single layer measurements based at least in part on one or more of codebook information or apparatus mobility measurements.

In some aspects, the means for determining the multiple layer measurements comprises combining the single layer measurements using a linear model.

In some aspects, the means for determining the multiple layer measurements comprises combining the single layer measurements using a non-linear model, wherein the non-linear model is trained and validated using one or more datasets associated with one or more of: channel models, apparatus rotations, apparatus analog beamforming codebooks, white noise with different SINRs, or non-white noise with different SINRs.

In some aspects, the means for determining the multiple layer measurements comprises: means for combining the single layer measurements using a linear model to obtain first multiple layer measurements; means for selecting a first apparatus beam pair based at least in part on the first multiple layer measurements; means for combining the single layer measurements using a non-linear model to obtain second multiple layer measurements; means for selecting a second apparatus beam pair based at least in part on the second multiple layer measurements; and means for selecting one of the first apparatus beam pair or the second apparatus beam pair based at least in part on a performance of the first apparatus beam pair in relation to a performance of the second apparatus beam pair.

In some aspects, the means for determining the multiple layer measurements comprises combining the single layer measurements to obtain single layer measurements associated with the one or more apparatus beam pairs and the multiple layer measurements associated with the one or more apparatus beam pairs.

In some aspects, an apparatus for wireless communication includes means for transmitting, to a UE, a single layer reference signal; and means for receiving, from the UE, a multiple layer transmission based at least in part on a UE beam pair, wherein the UE beam pair is based at least in part on the single layer reference signal.

In some aspects, the single layer reference signal is an SSB.

In some aspects, the UE beam pair is based at least in part on multiple layer measurements associated with one or more UE beam pairs of a plurality of UE beam pairs, and the multiple layer measurements are based at least in part on a combination of single layer measurements associated with the single layer reference signal.

In some aspects, the single layer measurements include one or more of: single layer RSRP measurements, single layer spectral efficiency measurements, or single layer channel frequency response measurements; and the multiple layer measurements are multiple layer spectral efficiency measurements.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 is a diagram illustrating an example of a base station baseband precoder and UE baseband processing, in accordance with the present disclosure.

FIG. 4 is a diagram illustrating an example associated with selecting a beam pair using single layer measurements, in accordance with the present disclosure.

FIG. 5 is a diagram illustrating an example associated with beam selection, in accordance with the present disclosure.

FIG. 6 is a diagram illustrating examples associated with beam selection using non-linear models, in accordance with the present disclosure.

FIGS. 7-8 are diagrams illustrating example processes associated with selecting a beam pair using single layer measurements, in accordance with the present disclosure.

FIGS. 9-10 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

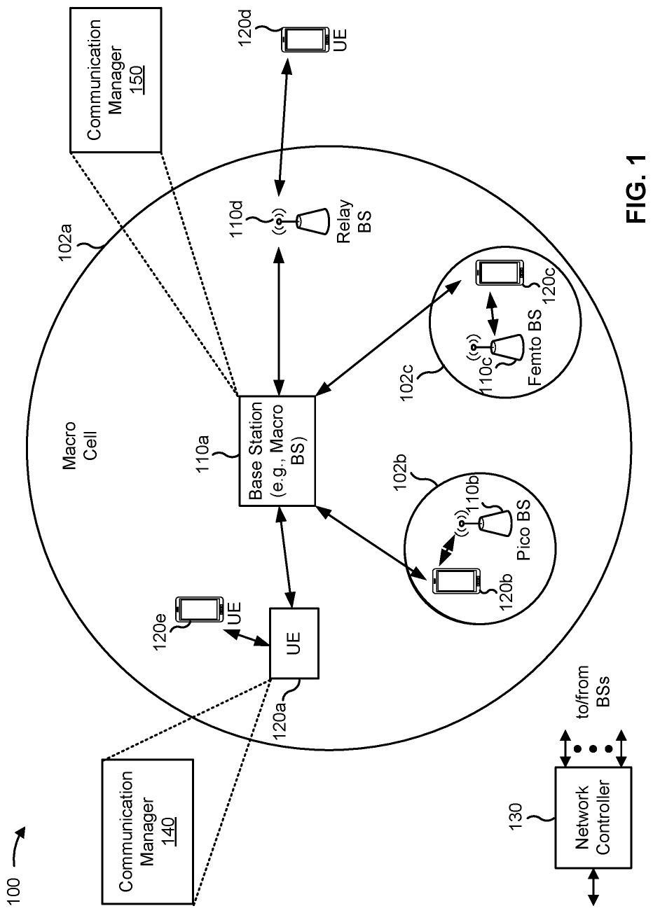

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR base station, a Node B, a gNB, a 5G node B (NB), an access point, a transmit receive point (TRP), or the like. Each base station may provide communication coverage for a particular geographic area. In 3GPP, the term “cell” can refer to a coverage area of a base station and/or a base station subsystem serving this coverage area, depending on the context in which the term is used.

A base station may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A base station for a macro cell may be referred to as a macro base station. A base station for a pico cell may be referred to as a pico base station. A base station for a femto cell may be referred to as a femto base station or a home base station. In the example shown in FIG. 1, a base station 110a may be a macro base station for a macro cell 102a, a base station 110b may be a pico base station for a pico cell 102b, and a base station 110c may be a femto base station for a femto cell 102c. A base station may support one or multiple (e.g., three) cells. The terms “eNB”, “base station”, “NR base station”, “gNB”, “TRP”, “AP”, “node B”, “5G NB”, and “cell” may be used interchangeably herein.

In some aspects, a cell may not necessarily be stationary, and the geographic area of the cell may move according to the location of a mobile base station. In some aspects, the base stations may be interconnected to one another and/or to one or more other base stations or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a base station or a UE) and send a transmission of the data to a downstream station (e.g., a UE or a base station). A relay station may also be a UE that can relay transmissions for other UEs. In the example shown in FIG. 1, a relay base station 110d may communicate with macro base station 110a and a UE 120d in order to facilitate communication between base station 110a and UE 120d. A relay base station may also be referred to as a relay station, a relay base station, a relay, or the like.

Wireless network 100 may be a heterogeneous network that includes base stations of different types, such as macro base stations, pico base stations, femto base stations, relay base stations, or the like. These different types of base stations may have different transmit power levels, different coverage areas, and different impacts on interference in wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to a set of base stations and may provide coordination and control for these base stations. Network controller 130 may communicate with the base stations via a backhaul. The base stations may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, a UE (e.g., UE 120) may include a communication manager 140. As described in more detail elsewhere herein, the communication manager 140 may receive, from a base station, a single layer reference signal; perform single layer measurements associated with the single layer reference signal for a plurality of UE beam pairs; determine, based at least in part on the single layer measurements for the plurality of UE beam pairs, multiple layer measurements associated with one or more UE beam pairs of the plurality of UE beam pairs; and select, from the one or more UE beam pairs, a UE beam pair based at least in part on the multiple layer measurements associated with the one or more UE beam pairs. Additionally, or alternatively, the communication manager 140 may perform one or more other operations described herein.

In some aspects, a base station (e.g., base station 110) may include a communication manager 150. As described in more detail elsewhere herein, the communication manager 150 may transmit, to a UE, a single layer reference signal; and receive, from the UE, a multiple layer transmission based at least in part on a UE beam pair, wherein the UE beam pair is based at least in part on the single layer reference signal. Additionally, or alternatively, the communication manager 150 may perform one or more other operations described herein.

As indicated above, FIG. 1 is provided as an example. Other examples may differ from what is described with regard to FIG. 1.

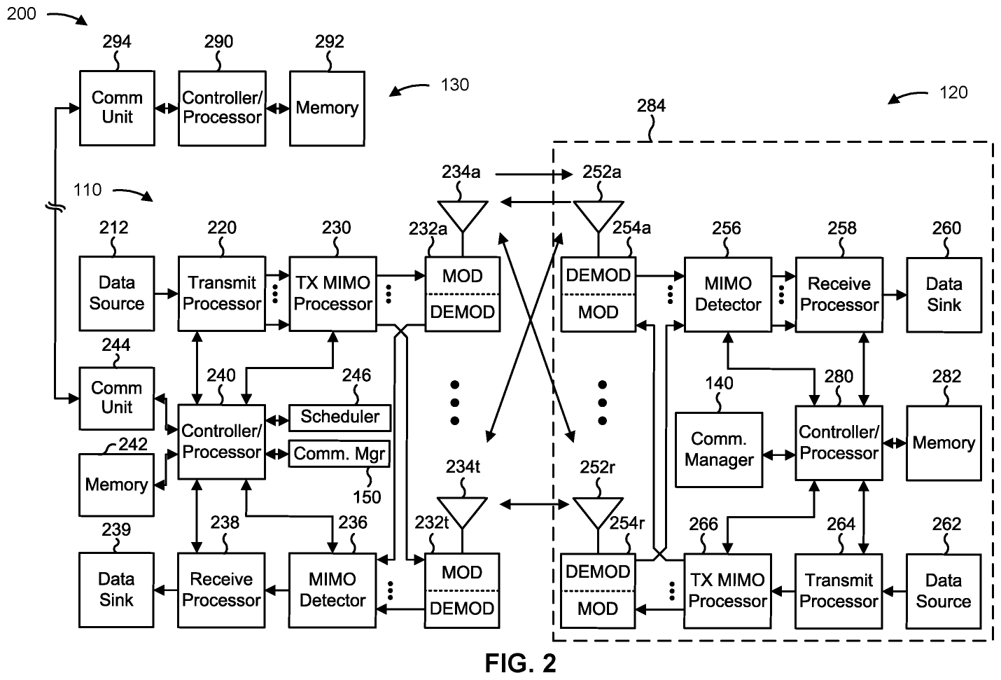

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine an RSRP parameter, a received signal strength indicator (RSSI) parameter, a reference signal received quality (RSRQ) parameter, an/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

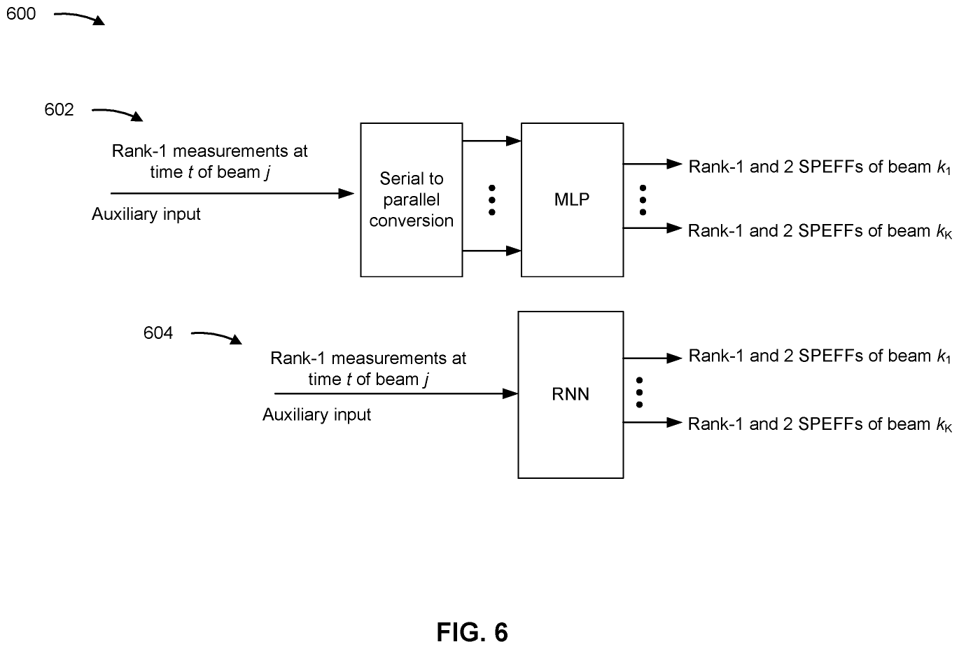

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM) and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 6-10).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 6-10).

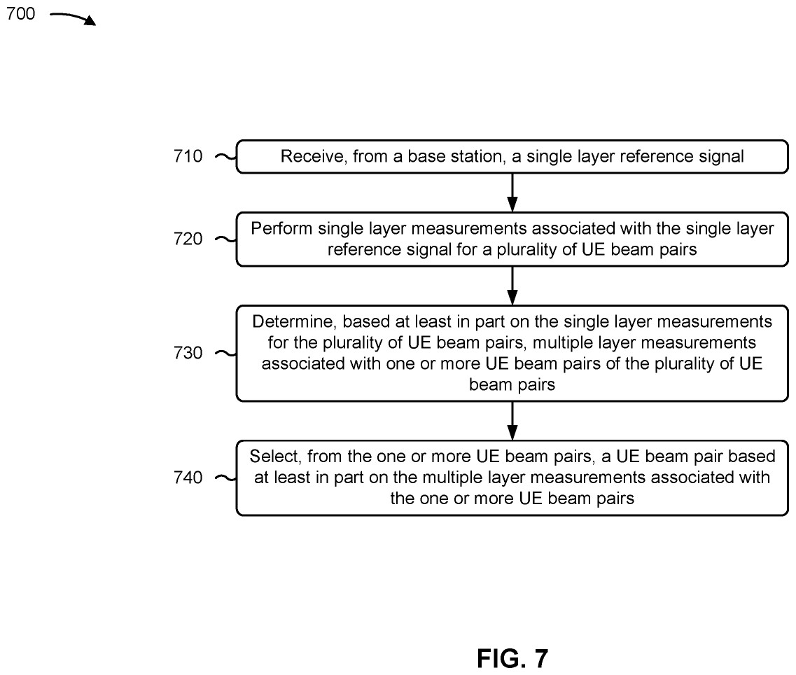

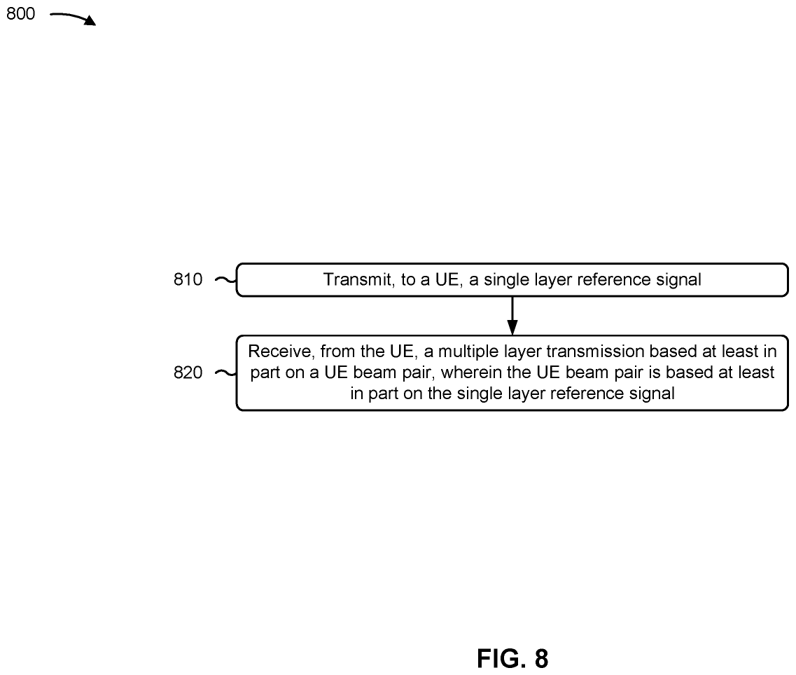

Controller/processor 240 of base station 110, controller/processor 280 of UE 120, and/or any other component(s) of FIG. 2 may perform one or more techniques associated with selecting a beam pair using single layer measurements, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some aspects, executing instructions may include running the instructions, converting the instructions, compiling the instructions, and/or interpreting the instructions.

In some aspects, a UE (e.g., UE 120) includes means for receiving, from a base station, a single layer reference signal; means for performing single layer measurements associated with the single layer reference signal for a plurality of UE beam pairs; means for determining, based at least in part on the single layer measurements for the plurality of UE beam pairs, multiple layer measurements associated with one or more UE beam pairs of the plurality of UE beam pairs; and/or means for selecting, from the one or more UE beam pairs, a UE beam pair based at least in part on the multiple layer measurements associated with the one or more UE beam pairs. The means for the UE to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, a base station (e.g., base station 110) includes means for transmitting, to a UE, a single layer reference signal; and/or means for receiving, from the UE, a multiple layer transmission based at least in part on a UE beam pair, wherein the UE beam pair is based at least in part on the single layer reference signal. The means for the base station to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

As indicated above, FIG. 2 is provided as an example. Other examples may differ from what is described with regard to FIG. 2.

In a millimeter wave system, a base station and a UE may support analog beamforming. In analog beamforming, high dimensional antennas-to-antennas MIMO channels may be converted to low dimensional beam-ports-to-beam-ports MIMO channels. The UE may perform measurements of each beam in a set of analog beams. The measurements may be RSRP measurements and/or spectral efficiency measurements. The UE may perform a beam selection based at least in part on the measurements of each beam in the set of analog beams. During the beam selection, the UE may select a subset of UE beams as serving beams. The subset of UE beams selected as the serving beams may maximize a channel spectral efficiency as compared to other subsets of UE beams. The UE may select two UE beams, which may form a UE beam pair, to support a multiple layer transmission, such as a rank-2 transmission.

The RSRP measurements and/or the spectral efficiency measurements may be associated with a single layer (e.g., a rank-1) or multiple layers (e.g., rank-2), based at least in part on a quantity of layers of reference signals to be measured at the UE. In other words, the quantity of layers of reference signals to be measured at the UE may correspond to whether the RSRP measurements and/or the spectral efficiency measurements are a rank-1 or a rank-2. The reference signals may have unknown time-variant precoding matrices, which may impact single layer measurements or multiple layer measurements as well.

Some beam management systems may only rely on single layer reference signals, such as an SSB with an unknown precoding matrix. In such beam management systems, beam selection may be based at least in part on single layer measurements of each beam pair in a set of analog beams. The beam selection may result in a beam pair selected from the set of analog beams, where a performance associated with the beam pair may be suitable for single layer transmissions, under certain precoding matrices. However, the beam pair may not be suitable for multiple layer transmissions, as the beam pair may cause significant throughput loss when used for multiple layer transmissions.

In various aspects of techniques and apparatuses described herein, a beam selection may be based at least in part on single layer measurements under various single layer precoding matrices. The single layer measurements may be single layer RSRP measurements, single layer spectral efficiency measurements, and/or single layer channel frequency response measurements. The beam selection may involve combining the single layer measurements across multiple UE beam pairs to predict multiple layer efficiency measurements of certain UE beams, as opposed to performing beam selection based at least in part on single layer measurements of individual UE pairs. Predicted multiple layer spectral efficiency measurements of certain UE beams may enable the UE to select a beam pair that is suitable for multiple layer transmissions.

In various aspects of techniques and apparatuses described herein, during the beam selection, the single layer measurements for the multiple UE beam pairs may be combined using linear filters, such as linear minimum mean square error (LMMSE) or adaptive linear filters, or using a neural network. Further, the beam selection that combines the single layer measurements across the multiple UE beam pairs may be more robust to unknown precoding matrices, as compared to when performing the beam selection based at least in part on the single layer measurements of individual UE pairs.

In various aspects of techniques and apparatuses described herein, beam selection based at least in part on single layer measurements of individual beam pairs may force a UE to select a beam pair directed toward a single layer link for a single layer transmission. However, by combining single layer measurements for multiple UE beams, the UE may select a beam pair that is favorable for multiple layer transmissions, which may double a throughput as compared to the single layer transmission. Single layer measurements of individual UE beam pairs without combining may not be suitable for multiple layer transmissions.

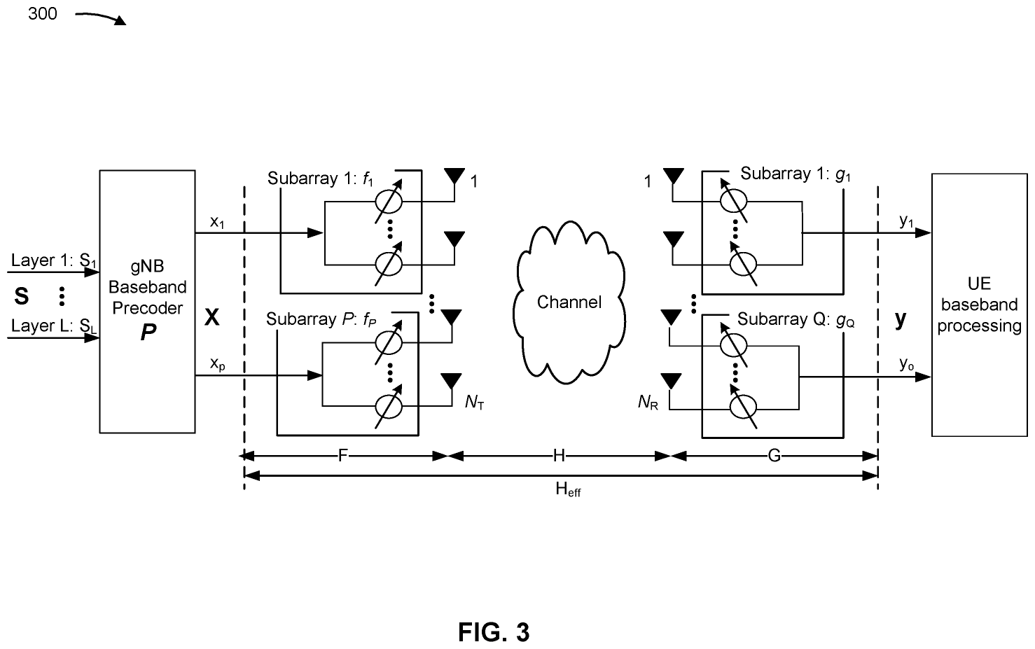

FIG. 3 is a diagram illustrating an example 300 of a base station baseband precoder and a UE baseband processing, in accordance with the present disclosure.

As shown in FIG. 3, a reference signal s may be an input to the base station baseband precoder P. The reference signal s may be associated with layers 1 through L (e.g., s₁, s₁, . . . s_{L}). The reference signal s, such as an SSB, may be a single layer reference signal (or a rank-1 reference signal). The base station baseband precoder P may be unknown to a UE and may be time variant. An output x of the base station baseband precoder P may be x₁ to xₚ, which may be used to form subarray 1 to subarray p. Subarray 1 to subarray p may correspond to f₁ to fₚ, where fₚ may represent a base station transmit analog beamformer in a p-th subarray (unknown to the UE). A base station may be associated with transmit antenna 1 to transmit antenna N_{T}, and the UE may be associated with receive antenna 1 to receive antenna N_{R}. At the UE, subarray 1 to subarray q may correspond to g₁ to g_{q}, where g_{q} may represent a UE receive analog beamformer in a q-th subarray (known by the UE). An output of subarray 1 to subarray q may be y, which may correspond to y₁ to y_{q}, and may be an input to a UE baseband processing.

A system input-output model at time t may be represented by y[t]=G[t]H[t]F[t]P[t]s[t]+z[t]=H_{eff}[t]P[t]s[t]+z[t], where F[t]=[f₁, f₂, . . . , f_{P}]∈C^{N}^{_{T}}^{×P} and G[t]=[g₁, g₂, . . . , g_{Q}]^{T}∈C^{Q×N}^{_{R}} are analog beamforming matrices at time t at the base station and the UE, respectively. Further, z[t] may be white or non-white (directional) noise due to cell-to-cell interference. A system optimizing goal may involve selecting transmit and receive analog beamformers fₚ|_{p=1, 2, . . . , P} and g_{q|q=1, 2, . . . , Q}, respectively, and the base station baseband precoder P to maximize a multiple layer spectral efficiency (e.g., a rank-2 spectral efficiency) of an effective channel matrix H_{eff}[t] under white or non-white noise z[t].

As indicated above, FIG. 3 is provided as an example. Other examples may differ from what is described with regard to FIG. 3.

A reference signal s, such as an SSB, may be associated with a single layer, and a single shot measurement of the reference signal s may not be able to predict multiple layer spectral efficiency measurements. In this case, multiple single layer measurements may be performed in multiple shots in time t and spatial beams g_{q}. The multiple single layer measurements may be combined to predict the multiple layer spectral efficiency measurements of certain UE beam pairs. Predicted multiple layer spectral efficiency measurements of certain UE beam pairs may enable a serving beam selection at the UE, such that the UE may select a UE beam pair that is suitable for multiple layer transmissions based at least in part on the predicted multiple layer spectral efficiency measurements.

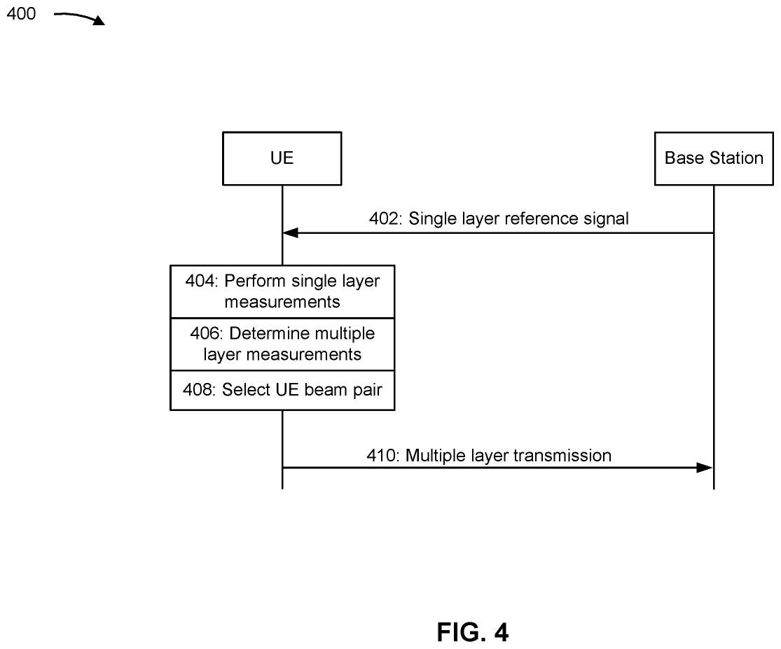

FIG. 4 is a diagram illustrating an example 400 associated with selecting a beam pair using single layer measurements, in accordance with the present disclosure. As shown in FIG. 4, example 400 includes communication between a UE (e.g., UE 120) and a base station (e.g., base station 110). In some aspects, the UE and the base station may be included in a wireless network, such as wireless network 100.

As shown by reference number 402, the UE may receive, from the base station, a single layer reference signal. The single layer reference signal may be a rank-1 reference signal. The single layer reference signal may be an SSB.

As shown by reference number 404, the UE may perform single layer measurements associated with the single layer reference signal for a plurality of UE beam pairs. The single layer measurements may be rank-1 measurements. The single layer measurements associated with the single layer reference signal may include single layer RSRP measurements (e.g., rank-1 RSRP measurements), single layer spectral efficiency measurements (e.g., rank-1 spectral efficiency measurements), or single layer channel frequency response measurements (e.g., rank-1 channel frequency response measurements).

As shown by reference number 406, the UE may determine, based at least in part on the single layer measurements for the plurality of UE beam pairs, multiple layer measurements associated with one or more UE beam pairs of the plurality of UE beam pairs. The multiple layer measurements may be rank-2 measurements. The multiple layer measurements may be spectral efficiency measurements (e.g., rank-2 spectral efficiency measurements).

In some aspects, the UE, to determine the multiple layer measurements, may combine the single layer measurements based at least in part on one or more of codebook information or UE mobility measurements. In some aspects, the UE, to determine the multiple layer measurements, may combine the single layer measurements using a linear model. In some aspects, the UE, to determine the multiple layer measurements, may combine the single layer measurements using a non-linear model, where the non-linear model may be trained and validated using one or more datasets associated with channel models, UE rotations, UE analog beamforming codebooks, white noise with different SINRs, and/or non-white noise with different SINRs. In some aspects, the UE, to determine the multiple layer measurements, may combine the single layer measurements to obtain single layer measurements associated with the one or more UE beam pairs and the multiple layer measurements associated with the one or more UE beam pairs.

In some aspects, the UE may combine the single layer measurements using a linear model to obtain first multiple layer measurements. The UE may select a first UE beam pair based at least in part on the first multiple layer measurements. The UE may combine the single layer measurements using a non-linear model to obtain second multiple layer measurements. The UE may select a second UE beam pair based at least in part on the second multiple layer measurements. The UE may select one of the first UE beam pair or the second UE beam pair based at least in part on a performance of the first UE beam pair in relation to a performance of the second UE beam pair.

As shown by reference number 408, the UE may select, from the one or more UE beam pairs, a UE beam pair based at least in part on the multiple layer measurements associated with the one or more UE beam pairs. For example, the UE may select the UE beam pair having the highest multiple layer measurements as compared to other UE beam pairs in the one or more UE beam pairs. In other words, the UE may perform a serving beam selection based at least in part on the multiple layer measurements associated with the one or more UE beam pairs.

As shown by reference number 410, the UE may perform, to the base station, a multiple layer transmission based at least in part on the UE beam pair, where the UE beam pair is based at least in part on the multiple layer measurements derived from the single layer reference signal. The multiple layer transmission may be a rank-2 transmission.

As indicated above, FIG. 4 is provided as an example. Other examples may differ from what is described with regard to FIG. 4.

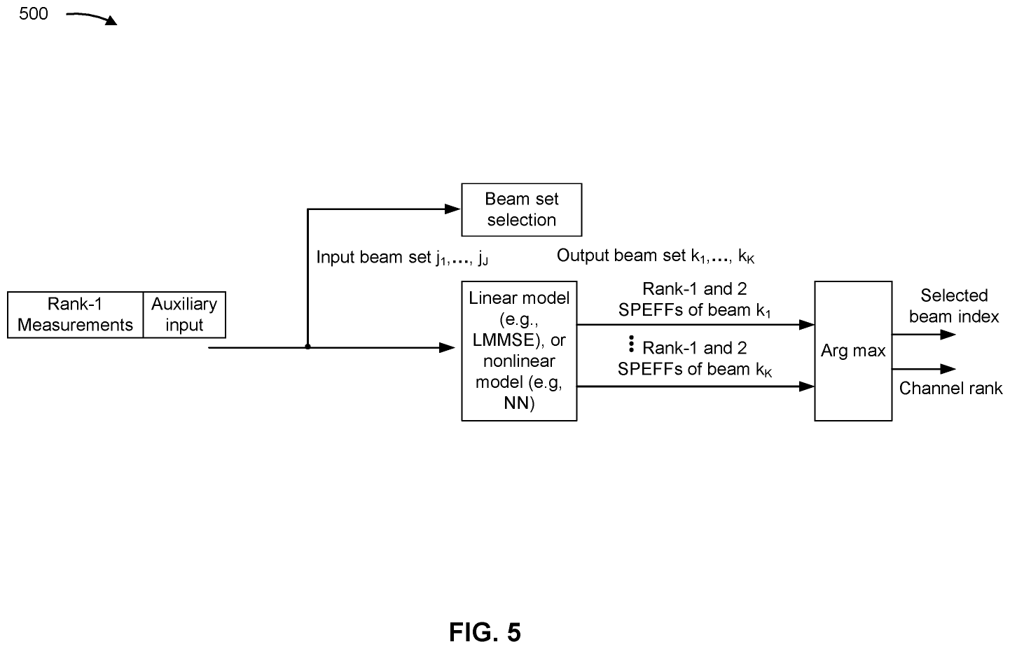

FIG. 5 is a diagram illustrating an example 500 associated with beam selection, in accordance with the present disclosure.

In some aspects, a UE may identify single layer measurements (e.g., rank-1 measurements) and an auxiliary input. The single layer measurements may be single layer RSRP measurements (e.g., rank-1 RSRP measurements), single layer spectral efficiency measurements (e.g., rank-1 spectral efficiency measurements), and/or single layer channel frequency response measurements (e.g., rank-1 channel frequency response measurements). The single layer measurements may be based at least in part on a reference signal, such as an SSB, received from a base station. As an example, the UE may include two receive ports and the base station may include two transmit ports. The UE may perform the single layer measurements in multiple timesteps using UE beams. The auxiliary input may include codebook embeddings, such as a low dimensional representation of beam gains. The auxiliary input may also include UE mobility measurements from inertial measurement unit (IMU) sensors and global positioning system (GPS) sensors, such as rotation speed, rotation axes, acceleration, and/or location.

In some aspects, the UE may provide the single layer measurements and the auxiliary input to a beam set selection process, which may output an input beam set j₁, . . . , j_{J} and an output beam set k₁, . . . , k_{K} based at least in part on the single layer measurements and the auxiliary input. The single layer measurements and the auxiliary input may be provided as inputs to a model, such as a linear model or a nonlinear model. For example, the linear model may be an LMMSE-based model, and the nonlinear model may be a neural network-based model. Further, the input beam set j₁, . . . , j_{J} and the output beam set k₁, . . . , k_{K} may be provided as inputs to the model. The model may output single layer and multiple layer spectral efficiency (SPEFF) measurements (e.g., rank-1 spectral efficiency measurements and rank-2 spectral efficiency measurements) of beams k₁, . . . , k_{K} based at least in part on the single layer measurements, the auxiliary input, the input beam set j₁, . . . , j_{J}, and the output beam set k₁, . . . , k_{K}. The model may output estimated single layer and multiple layer spectral efficiency measurements with multiple single layer and multiple layer precoders P for selected output beams k₁, . . . , k_{K}.

In some aspects, the UE may select a UE beam pair and/or a channel rank based at least in part on the single layer and multiple layer spectral efficiency measurements of beams k₁, . . . , k_{K}. For example, the UE may select a UE beam pair associated with a largest single layer and multiple layer spectral efficiency measurement as compared to other UE beam pairs. The UE beam pair may be associated with a beam index. In some aspects, the UE may use the selected UE beam pair to perform multiple layer transmissions to the base station.

As indicated above, FIG. 5 is provided as an example. Other examples may differ from what is described with regard to FIG. 5.

In some aspects, a linear estimator model may be represented by Ĉ_{rank2, k}=wₖ^{T}Cᵣₐₙₖ₁+bₖ, where Cᵣₐₙₖ₁=[C_{rank1, j}_{₁}, C_{rank1, j}_{₂}, . . . , C_{rank1, j}_{_{J}}]^{T} is a vector associated with single layer measurements from beam pairs, and wₖ and bₖ are associated with a weighting vector and a bias, respectively, to be optimized. In an LMMSE estimator, wₖ=R_{C}_{_{rank2, k}}_{, C}_{ᵣₐₙₖ₁} R_{C}_{ᵣₐₙₖ₁}_{,C}_{ᵣₐₙₖ₁}⁻¹, bₖ=C_{rank2, k}−wₖ^{T}C̅ᵣₐₙₖ₁, where R_{C}_{_{rank2, k}}_{,C}_{ᵣₐₙₖ₁} is a cross-covariance and R_{C}_{ᵣₐₙₖ₁}_{,C}_{ᵣₐₙₖ₁} is an auto-covariance, which may be estimated from training samples. The LMMSE estimator may handle both white noise and non-white noise, as the auto-covariance R_{C}_{ᵣₐₙₖ₁}_{,C}_{ᵣₐₙₖ₁} includes a noise co-variance matrix R_{z′}. For white noise, R_{z′} may be diagonal, and for non-white noise, R_{z′} may be non-diagonal.

In some aspects, UE beam selection may be based at least in part on LMMSE-predicted multiple layer spectral efficiency measurements, where the LMMSE-predicted multiple layer spectral efficiency measurements may be based at least in part on single layer spectral efficiency measurements. The UE beam selection may result in a UE beam pair, which may be used to perform a multiple layer transmission. The UE beam pair may outperform (e.g., in terms of throughput) a UE beam pair selected using single layer measurements when both UE beam pairs are used to perform multiple layer transmissions.

In some aspects, spectral efficiency prediction may be a non-linear problem, and may fit into a machine learning framework. Spectral efficiency measurements of UE beam pairs may be used as labels for supervised learning. The supervised learning may be used to train a model during an offline process due to relatively high computation complexity, and the model may be loaded onto a UE. Training and validation datasets may include various millimeter wave channel models (e.g., single-path channel models), UE rotations (e.g., rotation axes, UE orientation, and/or rotation speeds), UE analog beamforming codebooks, and/or white noise or non-white noise with different SINRs.

FIG. 6 is a diagram illustrating examples 600 associated with beam selection using non-linear models, in accordance with the present disclosure.

As shown by reference number 602, a non-linear model, such as a multi-layer perception (MLP) model, may be used to determine single layer and multiple layer spectral efficiency measurements of beams k₁, . . . , k_{K}. For example, single layer measurements at time t and beam j, as well as auxiliary input, may undergo a serial-to-parallel conversion and be provided as inputs to the MLP model. The MLP model may be trained using training and validation datasets, which may include various millimeter wave channel models, UE rotations, UE analog beamforming codebooks, and/or white/non-white noise with different SINRs. The MLP model may output the single layer and multiple layer spectral efficiency measurements of beams k₁, . . . , k_{K} based at least in part on the single layer measurements at time t and beam j and the auxiliary input.

As shown by reference number 604, a non-linear model, such as a recursive neural network (RNN) model, may be used to determine single layer and multiple layer spectral efficiency measurements of beams k₁, . . . , k_{K}. For example, single layer measurements at time t and beam j, as well as auxiliary input, may be provided as inputs to the RNN model. The RNN model may be trained using training and validation datasets, which may include various millimeter wave channel models, UE rotations, UE analog beamforming codebooks, and/or white/non-white noise with different SINRs. The RNN model may output the single layer and multiple layer spectral efficiency measurements of beams k₁, . . . , k_{K} based at least in part on the single layer measurements at time t and beam j and the auxiliary input.

In some aspects, regardless of whether a UE uses the MLP model or the RNN model, the UE may select a UE beam pair and/or a channel rank based at least in part on the single layer and multiple layer spectral efficiency measurements of beams k₁, . . . , k_{K}.

In some aspects, the UE may use both a linear model, such as the MLP model, and a non-linear model, such as the RNN model, to determine the single layer and multiple layer spectral efficiency measurements of beams k₁, . . . , k_{K}. The UE may evaluate a performance associated with the linear model versus a performance associated with the non-linear model, and the UE may perform a UE beam selection using single layer and multiple layer spectral efficiency measurements of beams k₁, . . . , k_{K} derived from either the linear model or the non-linear model.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with techniques for selecting a beam pair using single layer measurements.

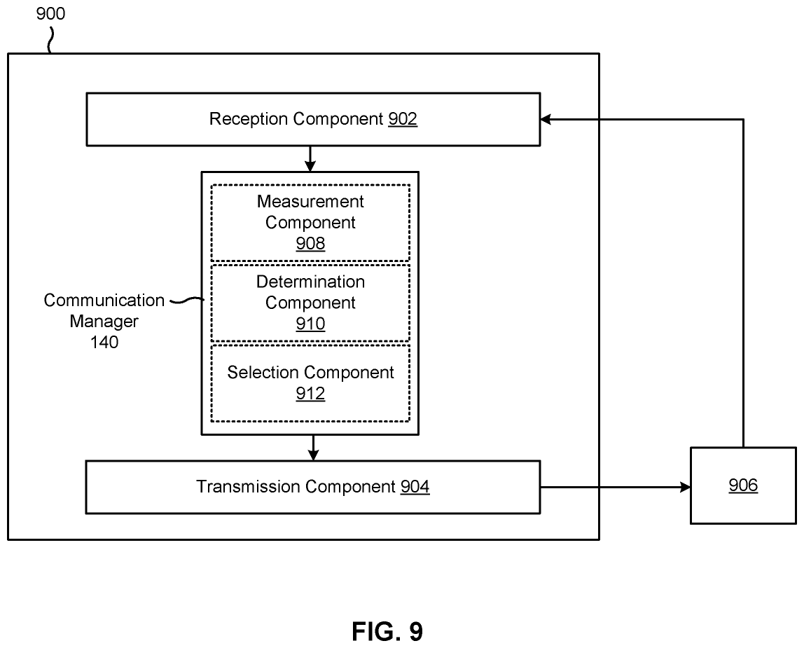

As shown in FIG. 7, in some aspects, process 700 may include receiving, from a base station, a single layer reference signal (block 710). For example, the UE (e.g., using communication manager 140 and/or reception component 902, depicted in FIG. 9) may receive, from a base station, a single layer reference signal, as described above.

As further shown in FIG. 7, in some aspects, process 700 may include performing single layer measurements associated with the single layer reference signal for a plurality of UE beam pairs (block 720). For example, the UE (e.g., using communication manager 140 and/or measurement component 908, depicted in FIG. 9) may perform single layer measurements associated with the single layer reference signal for a plurality of UE beam pairs, as described above.

As further shown in FIG. 7, in some aspects, process 700 may include determining, based at least in part on the single layer measurements for the plurality of UE beam pairs, multiple layer measurements associated with one or more UE beam pairs of the plurality of UE beam pairs (block 730). For example, the UE (e.g., using communication manager 140 and/or determination component 910, depicted in FIG. 9) may determine, based at least in part on the single layer measurements for the plurality of UE beam pairs, multiple layer measurements associated with one or more UE beam pairs of the plurality of UE beam pairs, as described above.

As further shown in FIG. 7, in some aspects, process 700 may include selecting, from the one or more UE beam pairs, a UE beam pair based at least in part on the multiple layer measurements associated with the one or more UE beam pairs (block 740). For example, the UE (e.g., using communication manager 140 and/or selection component 912, depicted in FIG. 9) may select, from the one or more UE beam pairs, a UE beam pair based at least in part on the multiple layer measurements associated with the one or more UE beam pairs, as described above.

Process 700 may include additional aspects, such as any single aspect or any combination of aspects described below and/or in connection with one or more other processes described elsewhere herein.

In a first aspect, process 700 includes performing, to the base station, a multiple layer transmission based at least in part on the UE beam pair.

In a second aspect, alone or in combination with the first aspect, the single layer measurements are rank-1 measurements and the multiple layer measurements are rank-2 measurements.

In a third aspect, alone or in combination with one or more of the first and second aspects, the single layer reference signal is an SSB.

In a fourth aspect, alone or in combination with one or more of the first through third aspects, the single layer measurements associated with the single layer reference signal include one or more of single layer RSRP measurements, single layer spectral efficiency measurements, or single layer channel frequency response measurements.

In a fifth aspect, alone or in combination with one or more of the first through fourth aspects, the multiple layer measurements are spectral efficiency measurements.

In a sixth aspect, alone or in combination with one or more of the first through fifth aspects, the determination of the multiple layer measurements includes combining the single layer measurements based at least in part on one or more of codebook information or UE mobility measurements.

In a seventh aspect, alone or in combination with one or more of the first through sixth aspects, the determination of the multiple layer measurements includes combining the single layer measurements using a linear model.

In an eighth aspect, alone or in combination with one or more of the first through seventh aspects, the determination of the multiple layer measurements includes combining the single layer measurements using a non-linear model, wherein the non-linear model is trained and validated using one or more datasets associated with one or more of channel models, UE rotations, UE analog beamforming codebooks, white noise with different SINRs, or non-white noise with different SINRs.

In a ninth aspect, alone or in combination with one or more of the first through eighth aspects, the determination of the multiple layer measurements includes combining the single layer measurements using a linear model to obtain first multiple layer measurements, selecting a first UE beam pair based at least in part on the first multiple layer measurements, combining the single layer measurements using a non-linear model to obtain second multiple layer measurements, selecting a second UE beam pair based at least in part on the second multiple layer measurements, and selecting one of the first UE beam pair or the second UE beam pair based at least in part on a performance of the first UE beam pair in relation to a performance of the second UE beam pair.

In a tenth aspect, alone or in combination with one or more of the first through ninth aspects, the determination of the multiple layer measurements includes combining the single layer measurements to obtain single layer measurements associated with the one or more UE beam pairs and the multiple layer measurements associated with the one or more UE beam pairs.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110) performs operations associated with techniques for selecting a beam pair using single layer measurements.

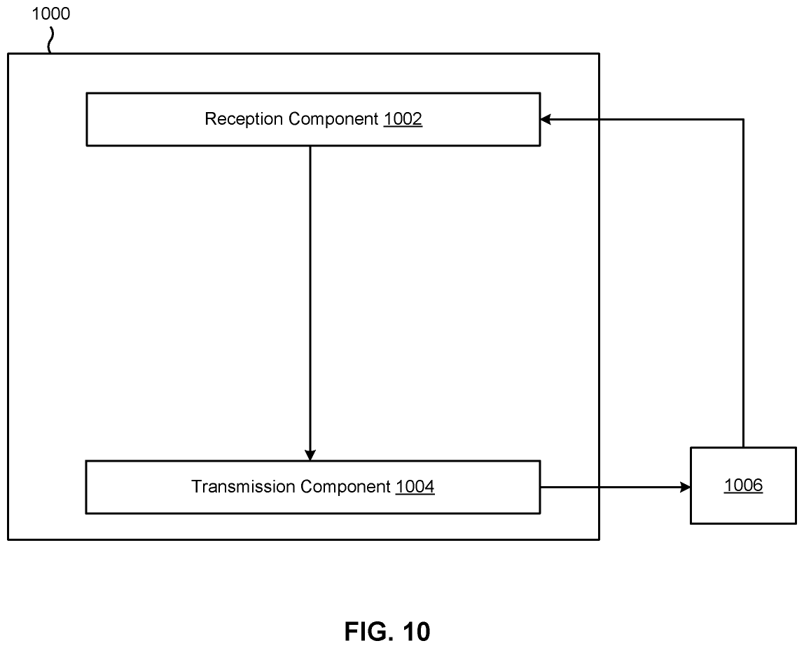

As shown in FIG. 8, in some aspects, process 800 may include transmitting, to a UE, a single layer reference signal (block 810). For example, the base station (e.g., using communication manager 150 and/or transmission component 1004, depicted in FIG. 10) may transmit, to a UE, a single layer reference signal, as described above.

As further shown in FIG. 8, in some aspects, process 800 may include receiving, from the UE, a multiple layer transmission based at least in part on a UE beam pair, wherein the UE beam pair is based at least in part on the single layer reference signal (block 820). For example, the base station (e.g., using communication manager 150 and/or reception component 1002, depicted in FIG. 10) may receive, from the UE, a multiple layer transmission based at least in part on a UE beam pair, wherein the UE beam pair is based at least in part on the single layer reference signal, as described above.

Process 800 may include additional aspects, such as any single aspect or any combination of aspects described below and/or in connection with one or more other processes described elsewhere herein.

In a first aspect, the single layer reference signal is an SSB.

In a second aspect, alone or in combination with the first aspect, the UE beam pair is based at least in part on multiple layer measurements associated with one or more UE beam pairs of a plurality of UE beam pairs, and the multiple layer measurements are based at least in part on a combination of single layer measurements associated with the single layer reference signal.

In a third aspect, alone or in combination with one or more of the first and second aspects, the single layer measurements include one or more of single layer RSRP measurements, single layer spectral efficiency measurements, or single layer channel frequency response measurements, and the multiple layer measurements are multiple layer spectral efficiency measurements.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a block diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a measurement component 908, a determination component 910, or a selection component 912, among other examples.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive, from a base station, a single layer reference signal. The measurement component 908 may perform single layer measurements associated with the single layer reference signal for a plurality of UE beam pairs. The determination component 910 may determine, based at least in part on the single layer measurements for the plurality of UE beam pairs, multiple layer measurements associated with one or more UE beam pairs of the plurality of UE beam pairs. The selection component 912 may select, from the one or more UE beam pairs, a UE beam pair based at least in part on the multiple layer measurements associated with the one or more UE beam pairs. The transmission component 904 may perform, to the base station, a multiple layer transmission based at least in part on the UE beam pair.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a block diagram of an example apparatus 1000 for wireless communication. The apparatus 1000 may be a base station, or a base station may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the base station described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the base station described in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the base station described in connection with FIG. 2. In some aspects, the transmission component 1004 may be co-located with the reception component 1002 in a transceiver.

The transmission component 1004 may transmit, to a UE, a single layer reference signal. The reception component 1002 may receive, from the UE, a multiple layer transmission based at least in part on a UE beam pair, wherein the UE beam pair is based at least in part on the single layer reference signal.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving, from a base station, a single layer reference signal; performing single layer measurements associated with the single layer reference signal for a plurality of UE beam pairs; determining, based at least in part on the single layer measurements for the plurality of UE beam pairs, multiple layer measurements associated with one or more UE beam pairs of the plurality of UE beam pairs; and selecting, from the one or more UE beam pairs, a UE beam pair based at least in part on the multiple layer measurements associated with the one or more UE beam pairs.

Aspect 2: The method of Aspect 1, further comprising: performing, to the base station, a multiple layer transmission based at least in part on the UE beam pair.

Aspect 3: The method of Aspect 1, wherein the single layer measurements are rank-1 measurements and the multiple layer measurements are rank-2 measurements.

Aspect 4: The method of Aspect 1, wherein the single layer reference signal is a synchronization signal block.

Aspect 5: The method of Aspect 1, wherein the single layer measurements associated with the single layer reference signal include one or more of: single layer reference signal received power measurements, single layer spectral efficiency measurements, or single layer channel frequency response measurements.

Aspect 6: The method of Aspect 1, wherein the multiple layer measurements are spectral efficiency measurements.

Aspect 7: The method of Aspect 1, wherein the determination of the multiple layer measurements comprises combining the single layer measurements based at least in part on one or more of codebook information or UE mobility measurements.

Aspect 8: The method of Aspect 1, wherein the determination of the multiple layer measurements comprises combining the single layer measurements using a linear model.

Aspect 9: The method of Aspect 1, wherein the determination of the multiple layer measurements comprises combining the single layer measurements using a non-linear model, wherein the non-linear model is trained and validated using one or more datasets associated with one or more of: channel models, UE rotations, UE analog beamforming codebooks, white noise with different signal-to-interference-plus-noise ratios (SINRs), or non-white noise with different SINRs.

Aspect 10: The method of Aspect 1, wherein the determination of the multiple layer measurements: combining the single layer measurements using a linear model to obtain first multiple layer measurements; selecting a first UE beam pair based at least in part on the first multiple layer measurements; combining the single layer measurements using a non-linear model to obtain second multiple layer measurements; selecting a second UE beam pair based at least in part on the second multiple layer measurements; and selecting one of the first UE beam pair or the second UE beam pair based at least in part on a performance of the first UE beam pair in relation to a performance of the second UE beam pair.

Aspect 11: The method of Aspect 1, wherein the determination of the multiple layer measurements comprises combining the single layer measurements to obtain single layer measurements associated with the one or more UE beam pairs and the multiple layer measurements associated with the one or more UE beam pairs.

Aspect 12: A method of wireless communication performed by a base station, comprising: transmitting, to a user equipment (UE), a single layer reference signal; and receiving, from the UE, a multiple layer transmission based at least in part on a UE beam pair, wherein the UE beam pair is based at least in part on the single layer reference signal.

Aspect 13: The method of Aspect 12, wherein the single layer reference signal is a synchronization signal block.

Aspect 14: The method of Aspect 12, wherein the UE beam pair is based at least in part on multiple layer measurements associated with one or more UE beam pairs of a plurality of UE beam pairs, and wherein the multiple layer measurements are based at least in part on a combination of single layer measurements associated with the single layer reference signal.

Aspect 15: The method of Aspect 14, wherein: the single layer measurements include one or more of: single layer reference signal received power measurements, single layer spectral efficiency measurements, or single layer channel frequency response measurements; and the multiple layer measurements are multiple layer spectral efficiency measurements.

Aspect 16: An apparatus for wireless communication at a device, comprising a processor; memory coupled with the processor; and instructions stored in the memory and executable by the processor to cause the apparatus to perform the method of one or more of Aspects 1-11.

Aspect 17: A device for wireless communication, comprising a memory and one or more processors coupled to the memory, the one or more processors configured to perform the method of one or more of Aspects 1-11.

Aspect 18: An apparatus for wireless communication, comprising at least one means for performing the method of one or more of Aspects 1-11.

Aspect 19: A non-transitory computer-readable medium storing code for wireless communication, the code comprising instructions executable by a processor to perform the method of one or more of Aspects 1-11.

Aspect 20: A non-transitory computer-readable medium storing a set of instructions for wireless communication, the set of instructions comprising one or more instructions that, when executed by one or more processors of a device, cause the device to perform the method of one or more of Aspects 1-11.

Aspect 21: An apparatus for wireless communication at a device, comprising a processor; memory coupled with the processor; and instructions stored in the memory and executable by the processor to cause the apparatus to perform the method of one or more of Aspects 12-15.

Aspect 22: A device for wireless communication, comprising a memory and one or more processors coupled to the memory, the one or more processors configured to perform the method of one or more of Aspects 12-15.

Aspect 23: An apparatus for wireless communication, comprising at least one means for performing the method of one or more of Aspects 12-15.

Aspect 24: A non-transitory computer-readable medium storing code for wireless communication, the code comprising instructions executable by a processor to perform the method of one or more of Aspects 12-15.

Aspect 25: A non-transitory computer-readable medium storing a set of instructions for wireless communication, the set of instructions comprising one or more instructions that, when executed by one or more processors of a device, cause the device to perform the method of one or more of Aspects 12-15.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving, from a base station, a single layer reference signal;
performing single layer measurements associated with the single layer reference signal for a plurality of UE beam pairs;
determining, based at least in part on the single layer measurements for the plurality of UE beam pairs, multiple layer measurements associated with one or more UE beam pairs of the plurality of UE beam pairs; and
selecting, from the one or more UE beam pairs, a UE beam pair based at least in part on the multiple layer measurements associated with the one or more UE beam pairs.

2. The method of claim 1, further comprising:
performing, to the base station, a multiple layer transmission based at least in part on the UE beam pair.

3. The method of claim 1, wherein the single layer measurements are rank-1 measurements and the multiple layer measurements are rank-2 measurements.

4. The method of claim 1, wherein the single layer reference signal is a synchronization signal block.

5. The method of claim 1, wherein the single layer measurements associated with the single layer reference signal include one or more of: single layer reference signal received power measurements, single layer spectral efficiency measurements, or single layer channel frequency response measurements.

6. The method of claim 1, wherein the multiple layer measurements are spectral efficiency measurements.

7. The method of claim 1, wherein the determination of the multiple layer measurements comprises combining the single layer measurements based at least in part on one or more of codebook information or UE mobility measurements.

8. The method of claim 1, wherein the determination of the multiple layer measurements comprises combining the single layer measurements using a linear model.

9. The method of claim 1, wherein the determination of the multiple layer measurements comprises combining the single layer measurements using a non-linear model, wherein the non-linear model is trained and validated using one or more datasets associated with one or more of: channel models, UE rotations, UE analog beamforming codebooks, white noise with different signal-to-interference-plus-noise ratios (SINRs), or non-white noise with different SINRs.

10. The method of claim 1, wherein the determination of the multiple layer measurements:
combining the single layer measurements using a linear model to obtain first multiple layer measurements;
selecting a first UE beam pair based at least in part on the first multiple layer measurements;
combining the single layer measurements using a non-linear model to obtain second multiple layer measurements;
selecting a second UE beam pair based at least in part on the second multiple layer measurements; and
selecting one of the first UE beam pair or the second UE beam pair based at least in part on a performance of the first UE beam pair in relation to a performance of the second UE beam pair.

11. The method of claim 1, wherein the determination of the multiple layer measurements comprises combining the single layer measurements to obtain single layer measurements associated with the one or more UE beam pairs and the multiple layer measurements associated with the one or more UE beam pairs.

12. A method of wireless communication performed by a base station, comprising:
transmitting, to a user equipment (UE), a single layer reference signal; and
receiving, from the UE, a multiple layer transmission based at least in part on a UE beam pair, wherein the UE beam pair is based at least in part on the single layer reference signal.

13. The method of claim 12, wherein the single layer reference signal is a synchronization signal block.

14. The method of claim 12, wherein the UE beam pair is based at least in part on multiple layer measurements associated with one or more UE beam pairs of a plurality of UE beam pairs, and wherein the multiple layer measurements are based at least in part on a combination of single layer measurements associated with the single layer reference signal.

15. The method of claim 14, wherein:
the single layer measurements include one or more of: single layer reference signal received power measurements, single layer spectral efficiency measurements, or single layer channel frequency response measurements; and
the multiple layer measurements are multiple layer spectral efficiency measurements.

16. A user equipment (UE) for wireless communication, comprising:
a memory; and
one or more processors, coupled to the memory, configured to:
receive, from a base station, a single layer reference signal;
perform single layer measurements associated with the single layer reference signal for a plurality of UE beam pairs;
determine, based at least in part on the single layer measurements for the plurality of UE beam pairs, multiple layer measurements associated with one or more UE beam pairs of the plurality of UE beam pairs; and
select, from the one or more UE beam pairs, a UE beam pair based at least in part on the multiple layer measurements associated with the one or more UE beam pairs.

17. The UE of claim 16, wherein the one or more processors are further configured to:
perform, to the base station, a multiple layer transmission based at least in part on the UE beam pair.

18. The UE of claim 16, wherein the single layer measurements are rank-1 measurements and the multiple layer measurements are rank-2 measurements.

19. The UE of claim 16, wherein the single layer reference signal is a synchronization signal block.

20. The UE of claim 16, wherein the single layer measurements associated with the single layer reference signal include one or more of: single layer reference signal received power measurements, single layer spectral efficiency measurements, or single layer channel frequency response measurements.

21. The UE of claim 16, wherein the multiple layer measurements are multiple layer spectral efficiency measurements.

22. The UE of claim 16, wherein the one or more processors, to determine the multiple layer measurements, are configured to combine the single layer measurements based at least in part on one or more of codebook information or UE mobility measurements.

23. The UE of claim 16, wherein the one or more processors, to determine the multiple layer measurements, are configured to combine the single layer measurements using a linear model.

24. The UE of claim 16, wherein the one or more processors, to determine the multiple layer measurements, are configured to combine the single layer measurements using a non-linear model, wherein the non-linear model is trained and validated using one or more datasets associated with one or more of: channel models, UE rotations, UE analog beamforming codebooks, white noise with different signal-to-interference-plus-noise ratios (SINRs), or non-white noise with different SINRs.

25. The UE of claim 16, wherein the one or more processors, to determine the multiple layer measurements, are configured to:
combine the single layer measurements using a linear model to obtain first multiple layer measurements;
select a first UE beam pair based at least in part on the first multiple layer measurements;
combine the single layer measurements using a non-linear model to obtain second multiple layer measurements;
select a second UE beam pair based at least in part on the second multiple layer measurements; and
select one of the first UE beam pair or the second UE beam pair based at least in part on a performance of the first UE beam pair in relation to a performance of the second UE beam pair.

26. The UE of claim 16, wherein the one or more processors, to determine the multiple layer measurements, are configured to combine the single layer measurements to obtain single layer measurements associated with the one or more UE beam pairs and the multiple layer measurements associated with the one or more UE beam pairs.

27. A base station for wireless communication, comprising:
a memory; and
one or more processors, coupled to the memory, configured to:
transmit, to a user equipment (UE), a single layer reference signal; and
receive, from the UE, a multiple layer transmission based at least in part on a UE beam pair, wherein the UE beam pair is based at least in part on the single layer reference signal.

28. The base station of claim 27, wherein the single layer reference signal is a synchronization signal block.

29. The base station of claim 27, wherein the UE beam pair is based at least in part on multiple layer measurements associated with one or more UE beam pairs of a plurality of UE beam pairs, and wherein the multiple layer measurements are based at least in part on a combination of single layer measurements associated with the single layer reference signal.

30. The base station of claim 29, wherein:
the single layer measurements include one or more of: single layer reference signal received power measurements, single layer spectral efficiency measurements, or single layer channel frequency response measurements; and
the multiple layer measurements are multiple layer spectral efficiency measurements.
